(19) United States
(12) Patent Application Publication
(10) Pub. No.: US 2026/0246219 A1
(43) Pub. Date: Aug. 20, 2026

(54) Floating Pusher and Crimping Device

(71) Applicants: AMP Amermex, S.A. de C.V., Juarez (MX); TE Connectivity Solutions GmbH, Schaffhausen (CH); Tyco Electronics (Shanghai) Co., Ltd., Shanghai (CN)

(72) Inventors: Yang Li, Shanghai (CN); Fengchun (Fred) Xie, Shanghai (CN); Sun Kyu Pak, Middletown, PA (US); Kyle Lunsford, Winston-Salem, NC (US); Juan Jose Ortega Garza, Hermosillo (MX)

(73) Assignees: AMP Amermex, S.A. de C.V., Juarez (MX); TE Connectivity Solutions GmbH, Schaffhausen (CH); Tyco Electronics (Shanghai) Co., Ltd., Shanghai (CN)

(21) Appl. No.: 19/544,099

(22) Filed: Feb. 19, 2026

(30) Foreign Application Priority Data
Feb. 19, 2025 (CN) 202510186194.7

(51) Int. Cl. H01R 43/048

(52) U.S. Cl. CPC H01R 43/048

(57) ABSTRACT

A floating pusher includes a vertical rod having upper and lower ends, a connection assembly connected to the upper end, an upper flange fitted on the vertical rod in a movable manner and located below the connection assembly, a lower flange fitted on the vertical rod in a movable manner and located below the upper flange, an upper spring fitted onto the vertical rod and compressed between the upper flange and the connection assembly, and a lower spring fitted onto the vertical rod and compressed between the upper flange and the lower flange. An elastic coefficient of the lower spring is smaller than that of the upper spring. The connection assembly connects to a crimping machine to move synchronously with a crimping tool. The lower flange pushes on a floating holder holding a hard wire to push, and keep, the floating holder to a predetermined position.

### CROSS-REFERENCE TO RELATED APPLICATION

This application claims the benefit of the filing date under 35 U.S.C. § 119(a)-(d) of Chinese Patent Application No. CN 202510186194.7 filed on Feb. 19, 2025, the whole disclosure of which is incorporated herein by reference.

### FIELD OF THE INVENTION

The present invention relates to a floating pusher and, more particularly, to a floating pusher and a crimping device comprising the floating pusher.

### BACKGROUND OF THE INVENTION

A crimping device is usually used to crimp a terminal onto an end of a wire. The crimping device typically includes a wire clamp, a positioning base, a crimping tool, and a crimping machine. The wire is clamped and fixed to the wire clamp, and the terminal is positioned on the positioning base. The crimping tool is located above the positioning base and connected to the crimping machine. The crimping machine is used to drive the crimping tool to move in the vertical direction. The crimping tool pushes the crimping part of the terminal under the drive of the crimping machine to crimp the crimping part of the terminal to the end of the wire. During the crimping process, the wire clamp is fixed and does not move synchronously with the crimping tool, which can cause the wire to bend or deform during the crimping process. If the wire is a flexible wire, there is no problem with certain bending and deformation. However, if the wire is a hard and brittle material, it can cause irreversible plastic deformation or fracture of the hard wire. Therefore, the existing crimping device is not suitable for crimping terminals onto hard wires.

### SUMMARY OF THE INVENTION

A floating pusher includes a vertical rod having upper and lower ends, a connection assembly connected to the upper end, an upper flange fitted on the vertical rod in a movable manner and located below the connection assembly, a lower flange fitted on the vertical rod in a movable manner and located below the upper flange, an upper spring fitted onto the vertical rod and compressed between the upper flange and the connection assembly, and a lower spring fitted onto the vertical rod and compressed between the upper flange and the lower flange. An elastic coefficient of the lower spring is smaller than that of the upper spring. The connection assembly connects to a crimping machine to move synchronously with a crimping tool. The lower flange pushes on a floating holder holding a hard wire to push, and keep, the floating holder to a predetermined position.

### BRIEF DESCRIPTION OF DRAWINGS

The invention will now be described by way of example with reference to the accompanying figures, of which:

FIG. 1 is a perspective view of a floating pusher according to an exemplary embodiment;

FIG. 2 is an axial sectional view of the floating pusher of FIG. 1;

FIG. 3 is an exploded view of the floating pusher of FIG. 1;

FIG. 4 is a schematic view of a crimping device according to an exemplary embodiment, where a crimping tool is in an initial position that is not in contact with a terminal;

FIG. 5 is a schematic view of the crimping device of FIG. 4, where the crimping tool of FIG. 4 is in an initial crimping position just in contact with the terminal of FIG. 4;

FIG. 6 is a schematic view of the crimping device of FIG. 4, where the crimping tool of FIG. 4 is in a final crimping position to crimp the terminal of FIG. 4 onto a hard wire; and

FIG. 7 is a schematic view of the crimping device of FIG. 4, in which the crimping tool of FIG. 4 returns from the final crimping position of FIG. 6 to the initial position of FIG. 4.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

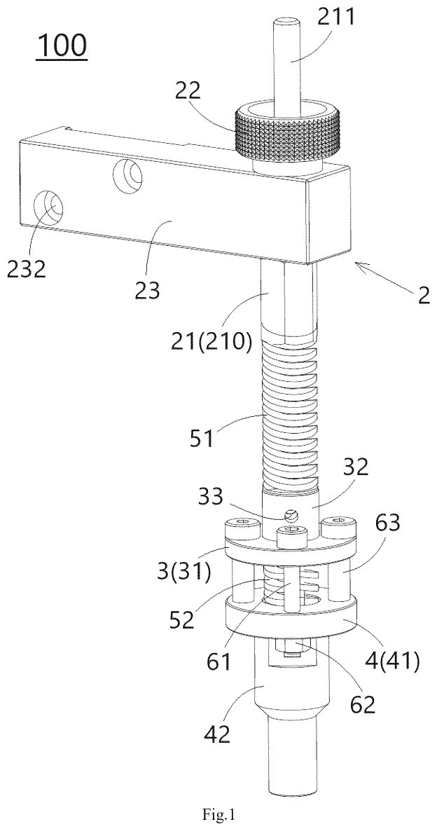

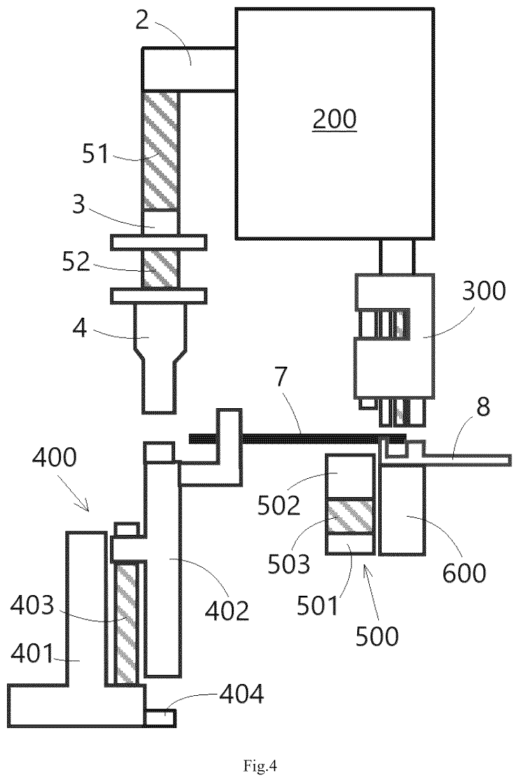

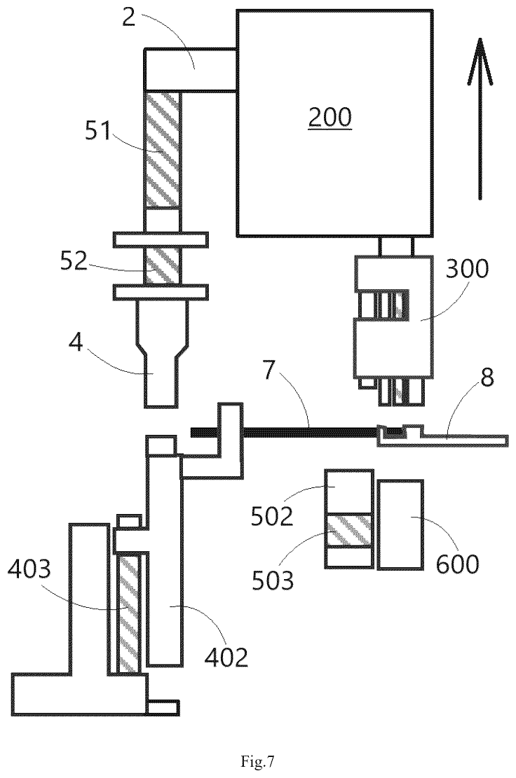

An exemplary embodiment of a floating pusher 100 will now be described with reference to FIGS. 1-7. As shown in FIGS. 1-3, the floating pusher 100 includes: a vertical rod 1, a connection assembly 2, an upper flange 3, a lower flange 4, an upper spring 51, and a lower spring 52. The vertical rod 1 extends in the vertical direction and has an upper end and a lower end. The connection assembly 2 is connected to the upper end of the vertical rod 1. The upper flange 3 is movably mounted on the vertical rod 1 and located below the connection assembly 2. The lower flange 4 is movably mounted on the vertical rod 1 and located below the upper flange 3. The upper spring 51 is fitted onto the vertical rod 1 and is suitable for being compressed between the upper flange 3 and the connection assembly 2. The lower spring 52 is fitted onto the vertical rod 1 and is suitable for being compressed between the upper flange 3 and the lower flange 4. The elastic coefficient of the lower spring 52 is smaller than that of the upper spring 51. Therefore, under the same compressive force, the elastic deformation of the lower spring 52 is greater than that of the upper spring 51. The connection assembly 2 is used to connect to a crimping machine 200 of a crimping device, as shown in FIGS. 4-7, to move synchronously with a crimping tool 300 of the crimping device. The lower flange 4 is used to push against the floating holder 400, which is used to hold the hard wire 7, of the crimping device to push the floating holder 400 to a predetermined position and hold it in the predetermined position. In the present invention, the pushing force applied to the floating holder 400 by the floating pusher 100 can follow the non-linear variation of the crimping tool 300.

As shown in FIGS. 1-3, the upper flange 3 includes an upper plate part 31, the lower flange 4 includes a lower plate part 41. The lower spring 52 is adapted to be compressed between the upper plate part 31 and the lower plate part 41.

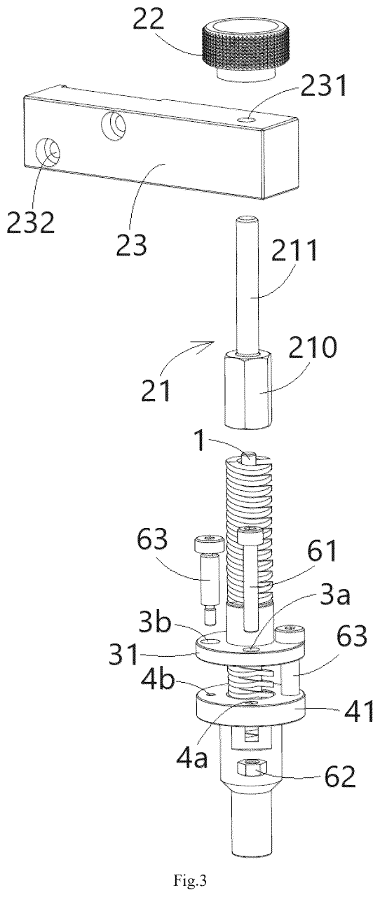

As shown in FIG. 3, an upper through hole 3a and a lower through hole 4a are formed in the upper plate part 31 of the upper flange 3 and the lower plate part 41 of the lower flange 4, respectively. As shown in FIG. 1, the floating pusher 100 also includes a bolt 61 passing through the upper through hole 3a and the lower through hole 4a and a nut 62 connected to the bolt 61, so that the initial length of the lower spring 52 can be adjusted by rotating the bolt 61 and nut 62, which makes the floating pusher 100 applicable to different crimping devices and expands the application range of the floating pusher 100.

As shown in FIG. 3, a guide hole 3b is formed in one of the upper plate part 31 and the lower plate part 41, and a threaded hole 4b is formed in the other. As shown in FIG. 1, the floating pusher 100 also includes a guide column 63 that passes through the guide hole 3b and is threaded with the threaded hole 4b at its lower end. The guide column 63 cooperates with the guide hole 3b to guide the lower plate part 41 to move along the axial direction of the vertical rod 1 relative to the upper plate part 31.

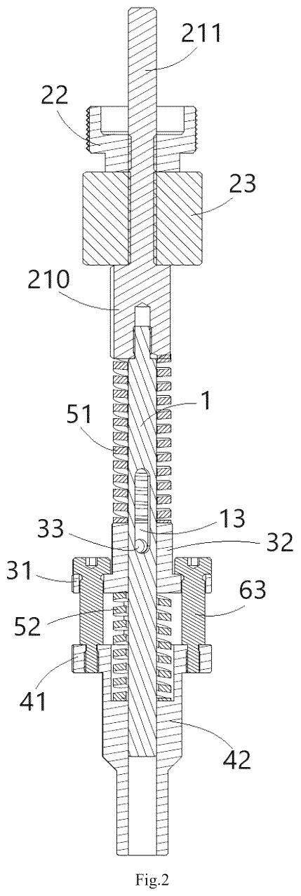

As shown in FIGS. 1-2, the upper flange 3 further includes an upper cylinder part 32 connected to the top surface of the upper plate part 31, and a pin hole 33 is formed in the upper cylinder part 32. A vertically extending slot hole 13, as shown in FIG. 2, is formed in the vertical rod 1. The floating pusher 100 also includes a pin that passes through the pin hole 33 and the slot hole 13 to connect the upper flange 3 to the vertical rod 1 in a movable manner.

As shown in FIGS. 1-2, the lower flange 4 further includes a lower cylinder part 42 connected to the bottom surface of the lower plate part 41. The lower end of the lower cylinder part 42 is used to push against the floating holder 400 of the crimping device.

As shown in FIG. 1, the connection assembly 2 includes a connecting block 23, a connecting column 21, and a fastening nut 22. The connecting block 23 is formed with a vertical connecting hole 231, as shown in FIG. 3. As shown in FIGS. 1-3, the connecting column 21 includes a positioning part 210 positioned on the bottom surface of the connecting block 23, and a screw part 211 connected to the positioning part 210 and passing through the vertical connecting hole 231. The fastening nut 22 rests against the top surface of the connecting block 23 and is threaded with the screw part 211 to fasten the connecting column 21 to the connecting block 23. The connecting block 23 is suitable for being connected to the crimping machine 200 of the crimping device. The positioning part 210 of the connecting column 21 is connected to the upper end of the vertical rod 1, and the upper spring 51 is suitable for being compressed between the positioning part 210 of the connecting column 21 and the upper flange 3.

As shown in FIG. 2, the upper end of the vertical rod 1 is threaded or welded to the positioning part 210 of the connecting column 21. However, the present invention is not limited to the illustrated embodiment, for example, the vertical rod 1 and the connecting column 21 may be integrated into one piece.

As shown in FIGS. 1 and 3, a horizontal connection hole 232 is formed in the connecting block 23 to allow a connection bolt to pass through, so that the connecting block 23 can be fastened to the crimping machine 200 of the crimping device through the connection bolt passing through the horizontal connection hole 232.

An exemplary embodiment of a crimping device will now be described with reference to FIGS. 1-7. As shown in FIGS. 1 and 4, the crimping device includes: a floating pusher 100, a crimping machine 200, a crimping tool 300, a floating holder 400, an elastic support seat 500, and a rigid support seat 600. The crimping tool 300 is used to crimp a terminal 8, as shown in FIGS. 4-7, onto an end of a hard wire 7, as shown in FIGS. 4-7. The rigid support seat 600 is used for positioning and supporting the terminal 8. The floating holder 400 is used to hold the hard wire 7. The elastic support seat 500 is adjacent to the rigid support seat 600, and is used for elastic support of the hard wire 7. The floating pusher 100 is used to push the floating holder 400. The crimping machine 200 is connected to the crimping tool 300 and the connection assembly 2 of the floating pusher 100. The crimping machine 200 is used to drive the crimping tool 300 and the connection assembly 2 of the floating pusher 100 to move synchronously in the vertical direction.

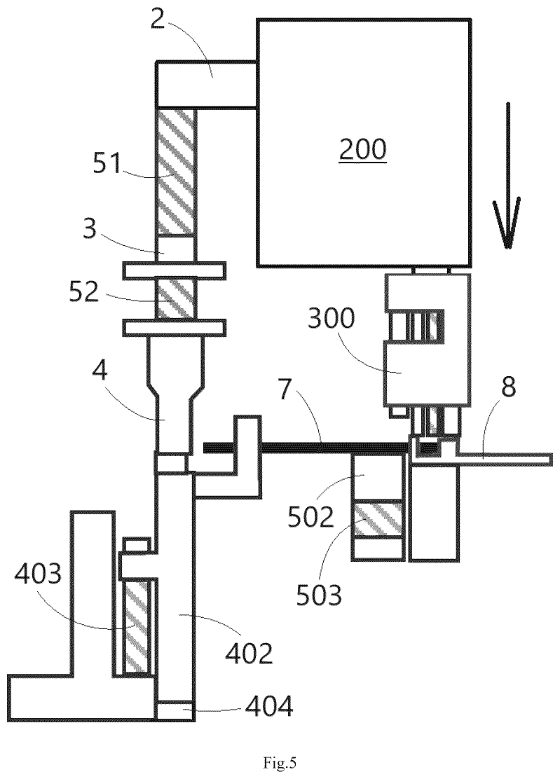

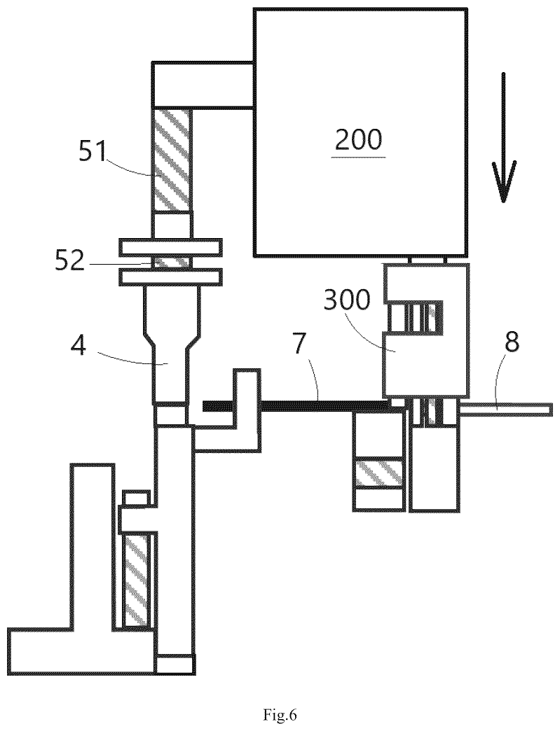

The crimping tool 300 is adapted to move downwards under the drive of the crimping machine 200 from an initial position not in contact with the terminal 8 (the position shown in FIG. 4) to an initial crimping position in contact with the terminal 8 (the position shown in FIG. 5), and from the initial crimping position to a final crimping position of crimping the terminal 8 onto the hard wire 7 (the position shown in FIG. 6).

When the crimping tool 300 is moved from the initial position to the initial crimping position, the floating holder 400 is moved downward from the starting position to the predetermined position under the pushing force of the floating pusher 100. When the floating holder 400 is moved from the starting position to the predetermined position, the hard wire 7 is moved from a position not in contact with the floating holder 400 to a position in contact with the elastic support seat 500, so that the end of the hard wire 7 is supported on the elastic support seat 500. When the crimping tool 300 is in the initial position, the lower flange 4 of the floating pusher 100 is not in contact with the floating holder 400, and the upper spring 51 and lower spring 52 of the floating pusher 100 are in an initial state where they are not compressed by external forces. When the crimping tool 300 is in the initial crimping position, the lower flange 4 of the floating pusher 100 presses against the floating holder 400, and the upper spring 51 and lower spring 52 of the floating pusher 100 are in the initial compressed state to apply a first pressing force on the floating holder 400. When the crimping tool 300 is in the final crimping position, the lower flange 4 of the floating pusher 100 presses against the floating holder 400, and the upper spring 51 and lower spring 52 of the floating pusher 100 are in the final compressed state, to apply a second pressing force greater than the first pressing force on the floating holder 400.

After the terminal 8 is crimped onto the hard wire 7, the crimping machine 200 drives the crimping tool 300 and the connection assembly 2 of the floating pusher 100 to move upward from the final crimping position to the initial position. During the process of moving the crimping tool 300 and the connection assembly 2 of the floating pusher 100 from the final crimping position to the initial position, the upper spring 51 and lower spring 52 of the floating pusher 100 gradually recover from the final compressed state to the initial state without external compression.

As shown in FIG. 4, the floating holder 400 includes a fixed frame 401, a floating frame 402, and a first spring 403. The first spring 403 is compressed between the floating frame 402 and the fixed frame 401. The hard wire 7 is held onto the floating frame 402 so as to be able to float together with the floating frame 402 relative to the fixed frame 401 between the starting position and the predetermined position.

As shown in FIGS. 4-5, a limiting part 404 is formed on the fixed frame 401. When the floating frame 402 is moved to the predetermined position, the limiting part 404 is pressed against the floating frame 402 to restrict the floating frame 402 in the predetermined position.

As shown in FIG. 4, the elastic support seat 500 includes a fixed seat 501, a floating seat 502, and a second spring 503. The second spring 503 is compressed between the fixed seat 501 and the floating seat 502. The end of the hard wire 7 is supported on the top of the floating seat 502.

In the aforementioned exemplary embodiments according to the present invention, the floating pusher 100 can act synchronously with the crimping tool 300, and the pushing force applied by the floating pusher 100 on the floating holder 400 follows the non-linear changes of the crimping tool 300. Therefore, the hard wire 7 will not bend or deform due to excessive force, ensuring that the hard wire 7 remains in a straight state during the crimping process.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A floating pusher, comprising:
a vertical rod with an upper end and a lower end;
a connection assembly connected to the upper end of the vertical rod;
an upper flange fitted on the vertical rod in a movable manner and located below the connection assembly;
a lower flange fitted on the vertical rod in a movable manner and located below the upper flange;
an upper spring fitted onto the vertical rod and compressed between the upper flange and the connection assembly; and
a lower spring fitted onto the vertical rod and compressed between the upper flange and the lower flange, an elastic coefficient of the lower spring is smaller than an elastic coefficient of the upper spring, the connection assembly connects to a crimping machine of a crimping device to move synchronously with a crimping tool of the crimping device, the lower flange pushes on a floating holder of the crimping device holding a hard wire to push the floating holder to a predetermined position and keep the floating holder in the predetermined position.

2. The floating pusher of claim 1, wherein the upper flange has an upper plate part, the lower flange has a lower plate part, and the lower spring is compressed between the upper plate part and the lower plate part.

3. The floating pusher of claim 2, wherein an upper through hole and a lower through hole are respectively formed in the upper plate part of the upper flange and the lower plate part of the lower flange, the floating pusher further comprises a bolt passing through the upper through hole and the lower through hole and a nut connected to the bolt, so that an initial length of the lower spring can be adjusted by rotating the bolt and the nut.

4. The floating pusher of claim 2, wherein a guide hole is formed in one of the upper plate part and the lower plate part, and a threaded hole is formed in the other of the upper plate part and the lower plate part, the floating pusher further comprises a guide column which passes through the guide hole, a lower end of the guide column is threaded with the threaded hole, the guide column guides the lower plate part to move relative to the upper plate part along an axial direction of the vertical rod.

5. The floating pusher of claim 2, wherein the upper flange has an upper cylinder part connected to a top surface of the upper plate part, a pin hole is formed in the upper cylinder part, and a vertically extending slot hole is formed in the vertical rod, the floating pusher further comprises a pin passing through the pin hole and the slot hole to moveably connect the upper flange to the vertical rod.

6. The floating pusher of claim 2, wherein the lower flange has a lower cylinder part connected to a bottom surface of the lower plate part, a lower end of the lower cylinder part pushes against the floating holder of the crimping device.

7. The floating pusher of claim 1, wherein the connection assembly has a connecting block, a connecting column, and a fastening nut, the connecting block is formed with a vertical connecting hole, the connecting column has a positioning part positioned on a bottom surface of the connecting block and a screw part connected to the positioning part and passing through the vertical connecting hole, the fastening nut rests against a top surface of the connecting block and is threaded with the screw part to fasten the connecting column to the connecting block, the connecting block is connected to the crimping machine of the crimping device, the positioning part of the connecting column is connected to the upper end of the vertical rod, and the upper spring is compressed between the positioning part of the connecting column and the upper flange.

8. The floating pusher of claim 7, wherein the upper end of the vertical rod is threaded or welded to the positioning part of the connecting column.

9. The floating pusher of claim 7, wherein the vertical rod and the connecting column are formed into an integral component.

10. The floating pusher of claim 7, wherein a horizontal connection hole is formed in the connecting block to allow a connection bolt to pass through, such that the connecting block is fastened to the crimping machine of the crimping device through the connection bolt passing through the horizontal connection hole.

11. A crimping device, comprising:
a crimping tool crimping a terminal onto an end of a hard wire;
a rigid support seat positioning and supporting the terminal;
a floating holder holding the hard wire;
an elastic support seat adjacent to the rigid support seat and elastically supporting the hard wire;
a floating pusher pushing the floating holder, the floating pusher includes a vertical rod, a connection assembly, an upper flange, a lower flange, an upper spring, and a lower spring, the vertical rod has an upper end and a lower end, the connection assembly is connected to the upper end of the vertical rod, the upper flange is fitted on the vertical rod in a movable manner and is located below the connection assembly, the lower flange is fitted on the vertical rod in a movable manner and is located below the upper flange, the upper spring is fitted onto the vertical rod and is compressed between the upper flange and the connection assembly, the lower spring is fitted onto the vertical rod and is compressed between the upper flange and the lower flange, an elastic coefficient of the lower spring is smaller than an elastic coefficient of the upper spring; and
a crimping machine connected to the crimping tool and the connection assembly of the floating pusher, the crimping machine drives the crimping tool and the connection assembly of the floating pusher to move synchronously in a vertical direction, the lower flange of the floating pusher pushes the floating holder to a predetermined position and keeps the floating holder in the predetermined position.

12. The crimping device of claim 11, wherein the crimping tool moves downward under a drive of the crimping machine from an initial position not in contact with the terminal to an initial crimping position in contact with the terminal, and from the initial crimping position to a final crimping position of crimping the terminal onto the hard wire.

13. The crimping device of claim 12, wherein when the crimping tool is moved from the initial position to the initial crimping position, the floating holder is moved downward from a starting position to the predetermined position under the pushing of the floating pusher, when the floating holder is moved from the starting position to the predetermined position, the hard wire is moved from a position not in contact with the floating holder to a position in contact with the elastic support seat, such that an end of the hard wire is supported on the elastic support seat.

14. The crimping device of claim 13, wherein when the crimping tool is in the initial position, the lower flange of the floating pusher is not in contact with the floating holder, and the upper spring and the lower spring of the floating pusher are in an initial state of not being compressed by external forces.

15. The crimping device of claim 14, wherein when the crimping tool is in the initial crimping position, the lower flange of the floating pusher presses against the floating holder, and the upper spring and the lower spring of the floating pusher are in an initial compressed state to apply a first pressing force on the floating holder.

16. The crimping device of claim 15, wherein when the crimping tool is in the final crimping position, the lower flange of the floating pusher presses against the floating holder, and the upper spring and the lower spring of the floating pusher are in a final compressed state to apply a second pressing force greater than the first pressing force on the floating holder.

17. The crimping device of claim 16, wherein after the terminal is crimped onto the hard wire, the crimping machine drives the crimping tool and the connection assembly of the floating pusher to move upward from the final crimping position to the initial position, during a process of moving the crimping tool and the connection assembly of the floating pusher from the final crimping position to the initial position, the upper spring and the lower spring of the floating pusher gradually recover from the final compressed state to the initial state without external compression.

18. The crimping device of claim 17, wherein the floating holder has a fixed frame, a floating frame, and a first spring which is compressed between the floating frame and the fixed frame, the hard wire is held onto the floating frame, the hard wire floats together with the floating frame relative to the fixed frame between the starting position and the predetermined position.

19. The crimping device of claim 18, wherein a limiting part is formed on the fixed frame, when the floating frame is moved to the predetermined position the limiting part is pressed against the floating frame to restrict the floating frame to the predetermined position.

20. The crimping device of claim 17, wherein the elastic support seat has a fixed seat, a floating seat, and a second spring which is compressed between the fixed seat and the floating seat, the end of the hard wire is supported on a top of the floating seat.
